(19) United States
(12) Patent Application Publication
(10) Pub. No.: US 2016/0380570 A1
(43) Pub. Date: Dec. 29, 2016

(54) MOTOR CONTROL CENTER INCLUDING AN INTEGRATED DUAL BUS CONFIGURATION

(71) Applicant: EATON CORPORATION, CLEVELAND, OH (US)

(72) Inventors: THOMAS ARTHUR FARR, CANDLER, NC (US); JON C. BEAVER, ASHEVILLE, NC (US)

(73) Assignee: EATON CORPORATION, CLEVELAND, OH (US)

(21) Appl. No.: 14/748,445

(22) Filed: Jun. 24, 2015

(51) Int. Cl. H02P 27/06; H02P 1/04

(52) U.S. Cl. CPC H02P 27/06; H02P 1/04

(57) ABSTRACT

A medium voltage drive and control system includes a dual bus configuration including an AC bus and a DC bus, a converter module connected to the AC bus and structured to receive AC power from the AC bus and convert the AC power to DC power, a DC link module coupled to the converter module and to the DC bus, wherein the DC link module is structured to store the DC power and provide the DC power to the DC bus, and a plurality of inverter modules, each inverter module being coupled to the DC bus and being structured to receive at least a portion of the DC power from the DC bus and convert the at least a portion of the DC power to quasi-sinusoidal AC output power for provision to a load associated with the inverter module.

### BACKGROUND

Field

The disclosed concept relates generally to motor control drives, and, more particularly, to a fully integrated medium voltage motor drive system that includes an integrated dual bus configuration.

Background Information

There are numerous situations where multiple alternating current (AC) motors are employed to drive heavy machinery. For example, multiple high horsepower electric AC motors are used in a pumping system, such as, without limitation, a water pumping system. As is known in the art, in such settings, there are a number of devices that can be used to control the AC motors. In particular, contactors, soft starters, and variable frequency drives (VFDs) (also referred to as adjustable frequency drives or AFDs) are different types of devices that can be used to control an AC motor in such a setting.

A contactor simply connects the motor directly across the AC line. A motor connected to the AC line will accelerate very quickly to full speed and draw a large amount of current during acceleration. A soft starter is a device used to slowly ramp a motor up to full speed, and/or slowly ramp the motor down to a stop. Reducing both current draw and the mechanical strain on the system are big advantages of using a soft starter in place of a contactor. A VFD is a solid state electronic power converting device used for controlling the rotational speed of an AC motor by controlling the frequency of the electrical power supplied to the motor. Typically, a VFD first converts an AC input power to a DC intermediate power. The DC intermediate power is then converted to a quasi-sinusoidal AC power for driving the motor. Thus, the main components of a typical VFD include a number of input isolation transformers coupled to the source of AC power, a converter, such as a number of rectifier bridge assemblies, for converting the AC source power into the DC intermediate power, a direct current (DC) bus and associated DC bus capacitors for storing the DC intermediate power, and an inverter for converting the stored DC intermediate power into a variable voltage, variable frequency AC voltage for driving the motor.

There are currently no integrated medium voltage motor control systems wherein multiple AC motors may be driven using a common AC bus while allowing multiple inverters to share a common DC bus. There is thus room for improvement in the field of motor control centers.

### SUMMARY

In one embodiment, a medium voltage drive and control system is provided that includes a dual bus configuration including an AC bus and a DC bus, the AC bus being structured to be coupled to an AC power source. The system also includes a converter module connected to the AC bus and structured to receive AC power from the AC bus and convert the AC power to DC power, a DC link module coupled to the converter module and to the DC bus, wherein the DC link module is structured to store the DC power and provide the DC power to the DC bus, and a plurality of inverter modules, each inverter module being coupled to the DC bus and being structured to receive at least a portion of the DC power from the DC bus and convert the at least a portion of the DC power to quasi-sinusoidal AC output power for provision to a load associated with the inverter module.

In another embodiment, a method of driving a plurality of loads is provided. The method includes receiving AC power from an AC bus coupled to an AC power source, converting the AC power to DC power in a converter module coupled to the AC bus, providing the DC power to a DC bus, receiving at least a portion of the DC power in a plurality of inverter modules, each inverter module being coupled to the DC bus, and in each inverter module, converting the received at least a portion of the DC power to quasi-sinusoidal AC output power for provision to a particular one of the loads associated with the inverter module.

### BRIEF DESCRIPTION OF THE DRAWINGS

A full understanding of the disclosed concept can be gained from the following description of the preferred embodiments when read in conjunction with the accompanying drawings in which:

FIG. 1 is a schematic diagram of a motor control center according to one exemplary embodiment of the disclosed concept; and

FIG. 2 is a schematic diagram of a motor control center according to an alternative exemplary embodiment of the disclosed concept.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

As employed herein, the term “number” shall mean one or an integer greater than one (i.e., a plurality).

As employed herein, the terms “hard bus”, “hard bussed” or “hard bussing” shall refer to a system of one or more electrical conductors that makes a common connection between a number of circuits or circuit components and that employs metallic, e.g., copper, brass or aluminum, strips or bars that are connected, e.g., bolted, together, as opposed to a cable or cables that are strung together to interconnect a number of circuits or circuit components (which is usually used for field connections).

As employed herein, the term “medium voltage” shall mean 1000V-15,000V.

The disclosed concept provides a medium voltage motor control system which uses one or more large converter sections interconnected with an integrated dual AC and DC bus. Multiple inverters, bypasses, or other motor control devices can then be connected to the dual buses to provide a system that shares the large pool of direct current and the common connection to the AC line.

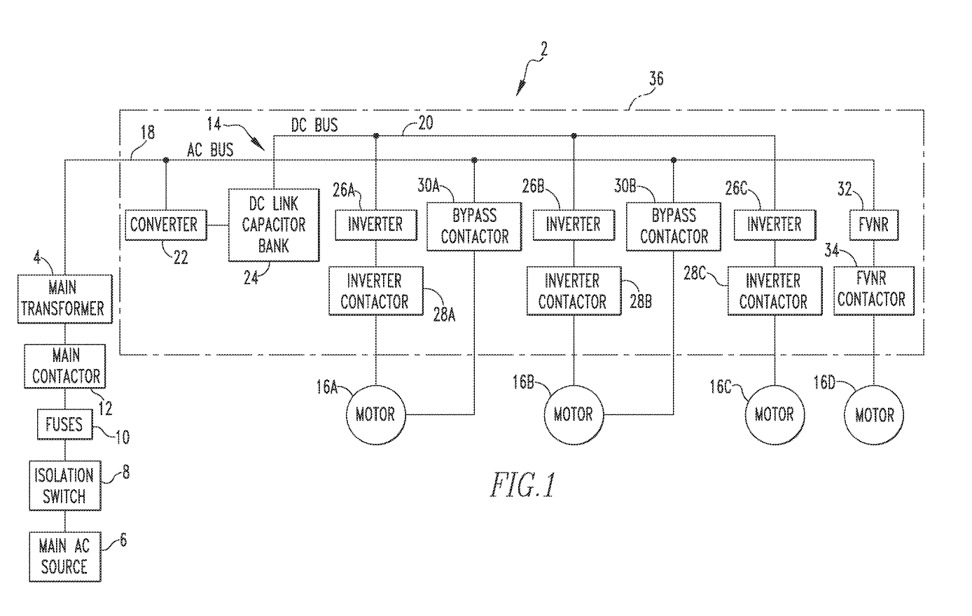

FIG. 1 is a schematic diagram of a medium voltage motor control center 2 according to one non-limiting exemplary embodiment of the disclosed concept. As seen in FIG. 1, motor control center 2 includes a main transformer 4 that is fed by a main AC source 6, such as the main electrical grid, through an isolation switch 8, main fuses 10, and a main contactor 12. In an alternative embodiment, main fuses 10 and main contactor 12 can be replaced by a circuit breaker or load break switch. In the non-limiting exemplary embodiment, main AC source 6 is a 4160V, poly-phase (e.g., three-phase) AC input, and main transformer 4 is a 3-phase, phase shifting transformer. Motor control center 2 further includes a dual bus drive system 14, described in detail herein, as a subassembly of motor control center 2 which is used to control and drive a plurality of medium voltage AC motors 16 (labeled 16A, 16B, 16C and 16D in the illustrated exemplary embodiment). In the non-limiting exemplary embodiment, each motor 16 is a medium voltage poly-phase motor 14, although it will be understood that this is exemplary only and that single phase motors or other AC loads may also be driven and controlled by the dual bus drive system 14.

Referring to FIG. 1, dual bus drive system 14 includes a common AC bus 18 and a common DC bus 20. In the exemplary embodiment, AC bus 18 and DC bus 20 are both hard bussed, and are made of, for example and without limitation, hard copper bus bars. As seen in FIG. 1, AC bus 18 is directly connected to the AC output of main transformer 4. Dual bus drive system 14 further includes a converter module 22 that is directly connected to AC bus 18. In the exemplary embodiment, converter module 22 includes a rectifier circuit, such as, for example, and without limitation, a 24 pulse diode bridge rectifier, an 18 pulse diode bridge rectifier, or a 12 pulse diode bridge rectifier. In an alternative embodiment, main transformer 4 and converter module 22 could be an alternative type of converter module, such as an active front end (AFE). Converter module 22 thus converts the poly-phase AC signal present on AC bus 18 into a DC signal. The DC output of converter module 22 is provided to a DC link capacitor bank 24. The output of DC link capacitor bank 24 is provided to DC bus 20. In the exemplary embodiment, converter module 22 is sized to provide the total direct current power requirements for the complete medium voltage motor control center 2 if all loads are running on variable frequency inverter control (for example, for six 500 HP motors, converter module 22 would be sized as a 3000 HP converter). Also, DC link capacitor bank 24 could be another type of DC link module, such as a reactor for a current source drive (DC link capacitor bank 24 is used for the illustrated voltage source drive).

As seen in FIG. 1, a plurality of inverter modules 26, labeled 26A, 26B, and 26C in the illustrated exemplary embodiment, are coupled to DC bus 20. In the exemplary embodiment, the DC bus 20 is interconnected horizontally between the plurality of inverter modules 26. Each inverter module 26 is structured to convert the DC input voltage received from DC bus 20 to poly-phase quasi-sinusoidal AC output power which may then be provided to the associated motor 16 through an associated inverter contactor 28 (labeled 28A, 28B and 28C in the illustrated exemplary embodiment). Each inverter module 26 may be any type of suitable inverter, such as, without limitation, a multi-level (e.g., 3-level) NPC inverter, although it will be understood that other suitable inverter topologies may also be used. Thus, according to an aspect of the disclosed concept, multiple loads (e.g., motors 16) may be driven using multiple inverter modules 26 all coupled to the same common DC bus 20 that receives DC power from a common converter module 22 and DC link capacitor bank 24 combination.

Furthermore, as seen in FIG. 1, in the illustrated embodiment, certain motors 16 may also be directly driven using AC power from the common AC bus 18 through an associated bypass contactor 30 provided between AC bus 18 and the associated motor 16. In the illustrated embodiment, two such configurations are provided such that motors 16A and 16B may be selectively driven in this manner. As seen in FIG. 1, motor 16C may only be driven through the associated inverter module 26C that is coupled to DC bus 20.

Moreover, according to a further aspect of the disclosed concept, a number of additional motor control devices may be coupled to the common AC bus 18 for driving a number of additional motors 16. For example, motor 16D shown in FIG. 1 is driven by a full voltage non-reversing (FVNR) motor starter 32 that is directly coupled to AC bus 18. In the illustrated embodiment, motor 16D is structured to receive the output of FVNR 32 through an FVNR contactor 34. FVNR 32 and FVNR contactor 34 could be replaced by any number of starter products, such as a reduced voltage soft starter (RVSS), a reduced voltage autotransformer starter (RVAT), reduced voltage primary reactor starter (RVPR), or a full voltage reversing starter (FVR).

In the non-limiting illustrated exemplary embodiment, at least AC bus 18, DC bus 20, converter module 22, DC link capacitor bank 24, inverter modules 26, inverter contactors 28, bypass contactors 30, FVNR 32 and FVNR contactor 34 are provided in an enclosure 36. In alternative embodiments, isolation switch 8, fuse 10, main contactor 12, and main transformer 4 they also be provided in enclosure 36. In the exemplary embodiment, enclosure 36 is an arc resistant enclosure that is structured to withstand an internal fault without endangering an operator who is standing in front of the equipment. In the exemplary embodiment, arc resistant enclosure 8 is structured to meet IEEE C37.20.7 standards, and thus be arc resistant at the front, sides and rear thereof, and to have the following arc resistant ratings: 50 kA-0.5 s, Type 2B.

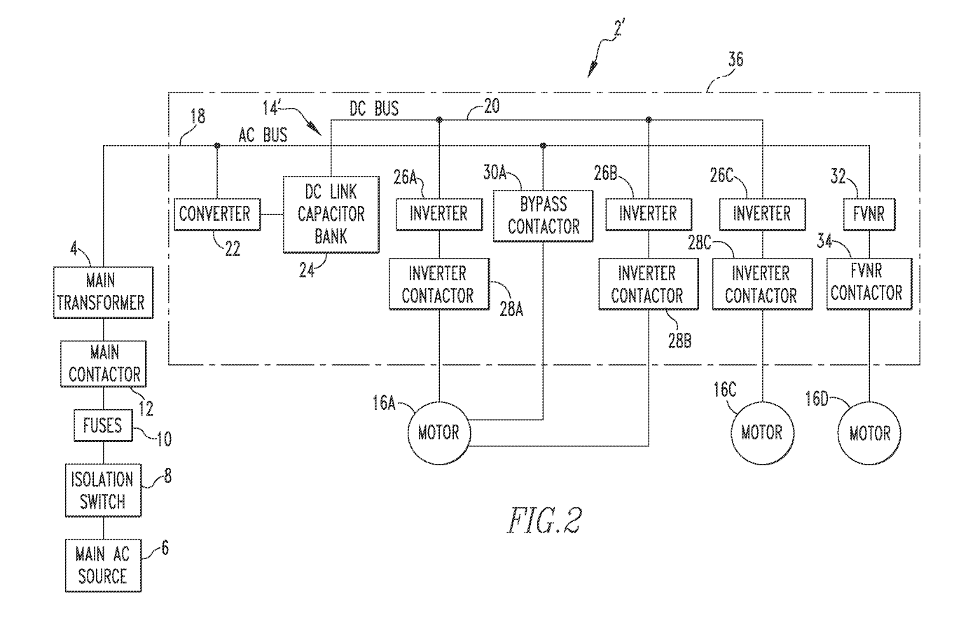

FIG. 2 is a schematic diagram of a motor control center 2′ according to an alternative exemplary embodiment of the disclosed concept. Motor control center 2′ includes many of the same components as motor control center 2, and like components are labeled with like reference numerals. However, as seen in FIG. 2, motor control center 2′ includes an alternative dual bus drive system 14′ that differs slightly from the dual bus drive system 14 of motor control center 2. In particular, in dual bus drive system 14′, inverter module 26B and inverter contactor 28B, rather than being used to drive an associated motor 16B, are instead coupled to motor 16A such that motor 16A may be selectively driven by either inverter module 26A or inverter module 26B depending upon the state of inverter contactors 28A, 28B. Thus, in such a configuration, inverter module 26B may be used as a backup inverter module which is coupled to motor 16A in the event that inverter module 26A fails.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A medium voltage drive and control system, comprising:
a dual bus configuration including an AC bus and a DC bus, the AC bus being structured to be coupled to an AC power source;
a converter module connected to the AC bus and structured to receive AC power from the AC bus and convert the AC power to DC power;
a DC link module coupled to the converter module and to the DC bus, wherein the DC link module is structured to store the DC power and provide the DC power to the DC bus; and
a plurality of inverter modules, each inverter module being coupled to the DC bus and being structured to receive at least a portion of the DC power from the DC bus and convert the at least a portion of the DC power to quasi-sinusoidal AC output power for provision to a load associated with the inverter module.

2. The medium voltage drive and control system according to claim 1, wherein the medium voltage drive and control system is a medium voltage motor drive and control system, and wherein each load is a medium voltage AC motor.

3. The medium voltage drive and control system according to claim 1, wherein the AC bus and the DC bus are both hard bussed.

4. The medium voltage drive and control system according to claim 3, wherein the AC bus, the DC bus, the converter module, the DC link module, and each of the inverter modules are provided within an enclosure.

5. The medium voltage drive and control system according to claim 4, wherein the enclosure is an arc resistant enclosure.

6. The medium voltage drive and control system according to claim 1, further comprising for at least one of the inverter modules a bypass contactor provided between the AC bus and the load associated with the at least one of the inverter modules.

7. The medium voltage drive and control system according to claim 2, further comprising an additional motor control device directly connected to the AC bus for driving an additional motor.

8. The medium voltage drive and control system according to claim 7, wherein the additional motor control device is a full voltage non-reversing motor starter.

9. A method of driving a plurality of loads, comprising:
receiving AC power from an AC bus coupled to an AC power source;
converting the AC power to DC power in a converter module coupled to the AC bus;
providing the DC power to a DC bus;
receiving at least a portion of the DC power in a plurality of inverter modules, each inverter module being coupled to the DC bus; and
in each inverter module, converting the received at least a portion of the DC power to quasi-sinusoidal AC output power for provision to a particular one of the loads associated with the inverter module.

10. The method according to claim 9, wherein each load is a medium voltage AC motor, and wherein the method comprises a method of driving and controlling each medium voltage AC motor.

11. The method according to claim 9, wherein the AC bus and the DC bus are both hard bussed.

12. The method according to claim 11, wherein the AC bus, the DC bus, the converter module, and each of the inverter modules are provided within an enclosure.

13. The method according to claim 12, wherein the enclosure is an arc resistant enclosure.

14. The method according to claim 10, further comprising providing the AC power to an additional motor control device directly coupled to the AC bus.

15. The method according to claim 14, wherein the additional motor control device is a full voltage non-reversing motor starter.
